(19) United States
(12) Patent Application Publication
(10) Pub. No.: US 2013/0047393 A1
(43) Pub. Date: Feb. 28, 2013

(54) CUP BELT FORK

(71) Applicant: Floyd McIlroy, Goodland, KS (US)

(72) Inventor: Floyd McIlroy, Goodland, KS (US)

(21) Appl. No.: 13/218,769

(22) Filed: Aug. 26, 2011

(51) Int. Cl. B65G 21/00; B23P 6/00

(52) U.S. Cl. 29/402.03; 198/860.1

(57) ABSTRACT

A device for supporting a cup belt conveyor system comprising: a first square tubing; a second square tubing; a middle square tubing joining the first square tubing with the second square tubing; an opening between the first square tubing and the second square tubing; and a series of bolts extending from the first square tubing, where the series of bolts secure the device at the top of a conveyor system and said opening allows the conveyor belt to pass through.

### BACKGROUND OF THE INVENTION

1. Field of Invention

The present invention relates to a cup belt fork utilized to repair pulley systems on a cup belt conveyor.

2. Description of Related Art

Conveyor systems are used throughout industry to handle material in various applications. Most conveyor systems utilize a belt-type conveyor system that includes pulleys that rotate a belt that in turn causes the movement of the material over the belt surface. Conveyor belt systems are used to transport various materials such as grain, coal or other types of materials in outdoor environments. Further conveyor systems are used indoors in manufacturing facilities to move the material over a process area. One particular conveyor system is a cup belt system that transports material through a series of cups that are positioned along the belt that is moved between two pulleys. Many times over the course of use the head pulley must be repaired or regular maintenance must be performed. When problems occur with the head pulley many times workers must remove all the weighty materials from the conveyer before releasing the belt legs in order to access the head pulley. Consequently, it would be advantageous to have a device that could support the pulley conveyor while workers access the head pulley for repairs.

### SUMMARY OF THE INVENTION

The present invention relates to a device for supporting a cup belt conveyor system comprising: a first square tubing; a second square tubing; a middle square tubing joining the first square tubing with the second square tubing; an opening between the first square tubing and the second square tubing; and a series of bolts extending from the first square tubing, where the series of bolts secure the device at the top of a conveyor system and said opening allows the conveyor belt to pass through. The present invention also includes a method of securing a cup belt conveyor system for a head pulley repair or maintenance comprising the steps of: placing a first belt fork on one side of a belt conveyor system; placing a second belt fork on an opposite side of the belt conveyor system; releasing a belt portion of the belt conveyor system to expose a head pulley of the conveyor system; reconnecting the belt portion upon completion of the repair or maintenance; and removing both the first belt fork and second belt fork. The step of placing may include bolting each belt fork to the conveyor system.

### BRIEF DESCRIPTION OF DRAWINGS

FIG. 1 shows a cup belt pulley system utilizing cup belt forks for support in accordance with the present invention.

FIG. 2 depicts a cup belt fork according to the present invention.

FIG. 3 depicts a top view showing use of the cup belt forks according to the present invention.

### DETAILED DESCRIPTION

The present invention relates to a device that is utilized to stabilize and support a cup belt conveyor while repairing a head pulley within the system. The belt fork in accordance with the present invention is a combination of square tubing that is placed at the top of the conveyor system to support the cup belt conveyor belt while accessing the head pulley for repairs and maintenance. The belt fork according to the present invention is bolted on to the sides of a conveyor as the conveyor belt is placed in between the opening of the belt fork. The belt fork opening is sufficient to allow for access of the conveyor belt but however it does not allow the cups attached to the belt through the opening and therefore supports the vertical sides of the conveyor system while the head pulley is accessed.

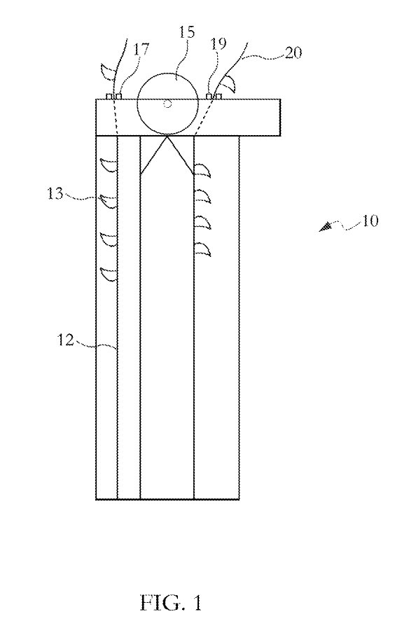

FIG. 1 depicts a Cup Belt Conveyor System 10. The Cup Belt Conveyor System 10 includes a series of Cups 13 attached to a Belt 12 that rotates over a Head Pulley 15. An opposing pulley is also provided at the bottom of the conveyor system although not shown in FIG. 1. The Head Pulley 15 must be made available for repair or maintenance by removing linkage in the Belt 12, when removed, an opening is provided as shown as FIG. 1. A Disconnect Point 20 is also shown at the top of the Belt 12. Belt Forks 17 and 19 are utilized to stabilize and support the Conveyor System 10 once the linkage is removed to access Pulley 15. Placement of the belt fork relieves pressure along the conveyor belt and allows for the safe removal of any linkage that supports the belt in place. The Belt Forks 17, 19 therefore support the weight of the conveyer system while the maintenance is performed on the Head Pulley 15.

FIG. 2 depicts a belt Fork 30 in accordance with the present invention. The belt Fork 30 includes a First Square Tubing 34 and a Second Square Tubing 32. A Middle Square Tubing 36 is provided between the First Square Tubing 34 and the Second Square Tubing 32. An open space is also provided between the First Square Tubing 34 and the Second Square Tubing 32. This configuration allows for the conveyor belt to be placed in this open space once the belt fork is bolted into place at the top of the conveyor system. A series of Bolts 31 are provided for securing the belt fork into place at the top of the conveyor system as shown in FIG. 1.

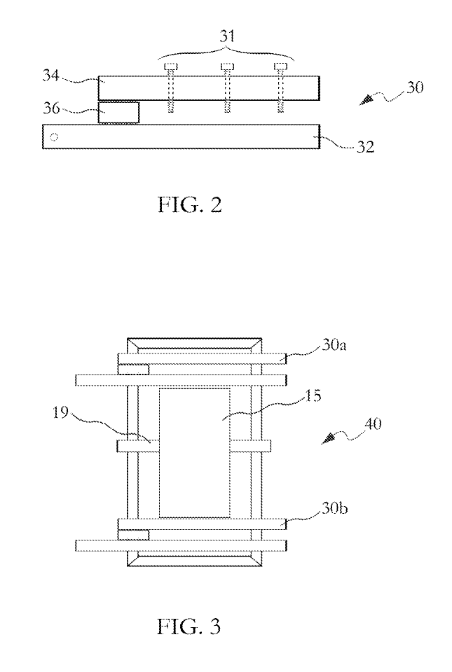

FIG. 3 depicts a top view of a Conveyor System 40 that has a Belt Fork 30a and a Second Belt Fork 30b placed at the top of Conveyor System 40. The First Belt Fork 30a secures one side of the conveyor system and the Second Belt Fork 30B secures the second side of the conveyor system. As shown in FIG. 3, the Pullley 15 is clearly exposed for repair. A Shaft 19 is also depicted which supports the Pulley 15 in place during use.

The belt fork device according to the present invention helps to reduce the number of workers and the amount of work required to effectively access the head pulley and the cup belt conveyor system. The belt fork according to the present invention provides adequate support of the conveyor system without removing the conveyor belt and the contents of the conveyor that may be remaining on the system when repairs are needed. The belt fork according to the present invention provides for adequate weight-bearing support and may be readily used to relieve the tension through the conveyor belt and head pulley during repair and maintenance. The instant invention has been shown and described in what it considers to be the most practical and preferred embodiments. It is recognized, however, that departures may be made there from within the scope of the invention and that obvious modifications will occur to a person skilled in the art.

What is claimed is:

1. A device for supporting a cup belt conveyor system comprising:
a. a first square tubing;
b. a second square tubing;
c. a middle square tubing joining the first square tubing with the second square tubing;
d. an opening between the first square tubing and the second square tubing; and
e. a series of bolts extending from the first square tubing, where the series of bolts secure the device at the top of a conveyor system and said opening allows the conveyor belt to pass through.

2. A method of securing a cup belt conveyor system for a head pulley repair or maintenance comprising the steps of:
a. placing a first belt fork on one side of a belt conveyor system;
b. placing a second belt fork on an opposite side of the belt conveyor system;
c. releasing a belt portion of the belt conveyor system to expose a head pulley of the conveyor system;
d. reconnecting the belt portion upon completion of the repair or maintenance; and
e. removing both the first belt fork and second belt fork.

3. The method of securing according to claim 2, where the step of placing includes bolting each belt fork to the conveyor system.
